(19) United States
(12) Patent Application Publication
(10) Pub. No.: US 2026/0099626 A1
(43) Pub. Date: Apr. 9, 2026

(54) Privacy Enabled Logging of User Data

(71) Applicant: Dell Products, L.P., Hopkinton, MA (US)

(72) Inventor: Anton Rang, Houlton, WI (US)

(21) Appl. No.: 18/908,925

(22) Filed: Oct. 8, 2024

(51) Int. Cl. G06F 21/62; G06F 21/60

(52) U.S. Cl. CPC G06F 21/6245; G06F 21/602

(57) ABSTRACT

When an application execution error occurs, an entry for the execution error is included in an error log. In instances where user data associated with the error should be preserved, a placeholder corresponding to the error is included in the error log. The placeholder contains pseudo data representing the user data, but is formatted in such a way to prevent the vendor from accessing the content of the data without additional authorization. When reviewing the log file, the vendor has visibility to the pseudo data contained in the placeholders, but is not able to discern the content of the user data from the pseudo data. In response to a request from the vendor to access instances of user data, the customer can selectively provide access to particular instances of user data that are deemed to not contain sensitive information.

### FIELD

This disclosure relates to computing systems and related devices and methods, and, more particularly, to a method and apparatus for privacy enabled logging of user data.

### SUMMARY

The following Summary and the Abstract set forth at the end of this document are provided herein to introduce some concepts discussed in the Detailed Description below. The Summary and Abstract sections are not comprehensive and are not intended to delineate the scope of protectable subject matter, which is set forth by the claims presented below.

All examples and features mentioned below can be combined in any technically possible way.

An application executing on a storage system containing customer data may experience an error, which may be caused by the underlying hardware of the storage system or by the application itself. The error is logged in a log file, which may subsequently be used by a vendor tasked with maintaining the storage system to determine the root cause of the error. To diagnose either hardware or software errors which result in data corruption, it may be necessary to examine both the correct and incorrect data. However, customers may be reluctant to expose their data or metadata to the vendor of the storage system, or the release may require special authorization, particularly where the data itself is highly confidential. Thus, storage systems, particularly those used in security sensitive industries, generally do not log corrupted data or metadata in the error logs. This may make it difficult or impossible for a vendor to debug an issue found at a customer to determine the root cause of the error.

According to some embodiments, a method and apparatus for privacy enabled logging of user data is provided. In some embodiments, when an error occurs that results in data corruption, a placeholder for the corrupted data and/or metadata associated with the error is stored in the log file. The placeholder contains pseudo data representing the corrupted data/metadata, but is formatted in such a way to prevent the vendor from accessing the content of the data/metadata without authorization from the customer. When reviewing the log file, the vendor has visibility to the pseudo data contained in the data placeholders, but is not able to discern the content of the user data from the pseudo data. In response to a request from the vendor to access the user data/metadata correlating to one or more of the placeholders, the customer can review the requested user data to identify instances of corrupted data/metadata that do not contain sensitive information. The pseudo data of a set of selected placeholders that are determined to not contain sensitive user data is then replaced with instances of the actual user data, such as corrupted user data/metadata, to enable the vendor to selectively have access to the actual user data in connection with implementation of root cause analysis. In instances where the corrupted data is automatically corrected by the storage system, placeholders containing pseudo data may be included in the log file for both the corrupted data as well as the corresponding corrected data.

In some embodiments, the pseudo data is created by encrypting the user data, such that the placeholder for the user data that is contained in the log file contains an encrypted version of the user data. In some embodiments, all instances of pseudo data are created using the same encryption key that is known to the customer but not to the vendor. In some embodiments, sets of instances of pseudo data are created using different encryption keys that are known to the customer but are not known to the vendor. In some embodiments, each instance of pseudo data is created using a respective unique encryption key that is known to the customer but not known to the vendor. In some embodiments, the pseudo data is created as a reference to an external storage location containing an instance of the customer data that is accessible only by the customer and is not accessible by the vendor without prior authorization from the customer.

In some embodiments, a method of privacy enabled logging of user data, includes determining occurrence of errors generated by an executing application, the executing application being used to process individual instances of user data, and logging the errors in an error log. For each error of a subset of the errors, the method includes identifying a corresponding instance of the user data that the executing application was processing at a time of occurrence of the error, generating a placeholder for the corresponding instance of the user data in the error log, generating a corresponding instance of pseudo data for the corresponding instance of the user data that the executing application was processing at the time of occurrence of the error, and including the generated corresponding instance of pseudo data in the placeholder in the error log.

In some embodiments, generating a corresponding instance of pseudo data comprises encrypting the corresponding instance of the user data that the executing application was processing at the time of occurrence of the error using an encryption key. In some embodiments, the same encryption key is used to generate corresponding instances of pseudo data for each error of the subset of the errors. In some embodiments, corresponding different encryption keys are used to generate respective corresponding instances of pseudo data for each error of the subset of the errors. In some embodiments, the method further includes encrypting corresponding different encryption keys for the respective corresponding instances of the pseudo data and storing the encrypted corresponding different encryption keys along with the respective corresponding instances of the pseudo data in the corresponding placeholders in the error log.

In some embodiments, generating a corresponding instance of pseudo data comprises storing the corresponding instance of the user data that the executing application was processing at the time of occurrence of the error at a secure storage location, and including a reference to the secure storage location as the pseudo data in the placeholder in the error log. In some embodiments, the secure storage location is a second storage location separate from a first storage location containing the error log, and wherein access to the first storage location containing the error log does not provide corresponding access to the second storage location containing the user data. In some embodiments, the user data is stored in encrypted form at the second storage location.

In some embodiments, the method further includes accessing the error log, requesting access to user data corresponding to particular instances of the pseudo data contained in one or more of the placeholders, and reviewing particular instances of user data corresponding to the requested particular instances of pseudo data to determine if the particular instances of pseudo data should be replaced with the particular instances of user data. For each instance of pseudo data, in response to a determination that the particular instance of pseudo data should be replaced with corresponding user data, the method includes replacing the pseudo data of the corresponding placeholder with the corresponding user data in the error log. In response to a determination that the particular instance of pseudo data should not be replaced with corresponding user data, the method includes maintaining the pseudo data of the corresponding placeholder in the error log.

### BRIEF DESCRIPTION OF THE DRAWINGS

FIG. 1 is a functional block diagram of a host computer connected to an example storage system, the host computer including a vendor diagnostic system configured to access log files of the storage system to assess errors occurring on the storage system, according to some embodiments.

FIG. 2 is a block diagram showing example application including control logic configured to implement operations on data, and containing an error log in which instances of application execution errors are recorded, according to some embodiments.

FIG. 3 is a block diagram showing an example process of privacy enhanced logging of user data, in which user data is logged in an error log using placeholders containing pseudo data, according to some embodiments.

FIG. 4 is a flow chart of an example process of privacy enhanced logging of user data, in which pseudo data instances of selected placeholders are converted to user data to enable a vendor to access to the user data in the log file, according to some embodiments.

### DETAILED DESCRIPTION

Aspects of the inventive concepts will be described as being implemented in a storage system 100 connected to a host computer 102. Such implementations should not be viewed as limiting. Those of ordinary skill in the art will recognize that there are a wide variety of implementations of the inventive concepts in view of the teachings of the present disclosure.

Some aspects, features and implementations described herein may include machines such as computers, electronic components, optical components, and processes such as computer-implemented procedures and steps. It will be apparent to those of ordinary skill in the art that the computer-implemented procedures and steps may be stored as computer-executable instructions on a non-transitory tangible computer-readable storage medium. Furthermore, it will be understood by those of ordinary skill in the art that the computer-executable instructions may be executed on a variety of tangible processor devices, i.e., physical hardware. For ease of exposition, not every step, device or component that may be part of a computer or data storage system is described herein. Those of ordinary skill in the art will recognize such steps, devices, and components in view of the teachings of the present disclosure and the knowledge generally available to those of ordinary skill in the art. The corresponding machines and processes are therefore enabled and within the scope of the disclosure.

The terminology used in this disclosure is intended to be interpreted broadly within the limits of subject matter eligibility. The terms “logical” and “virtual” are used to refer to features that are abstractions of other features, e.g., and without limitation, abstractions of tangible features. The term “physical” is used to refer to tangible features, including but not limited to electronic hardware. For example, multiple virtual computing devices could operate simultaneously on one physical computing device. The term “logic” is used to refer to special purpose physical circuit elements, firmware, and/or software implemented by computer instructions that are stored on a non-transitory tangible computer-readable storage medium and implemented by multi-purpose tangible processors, and any combinations thereof.

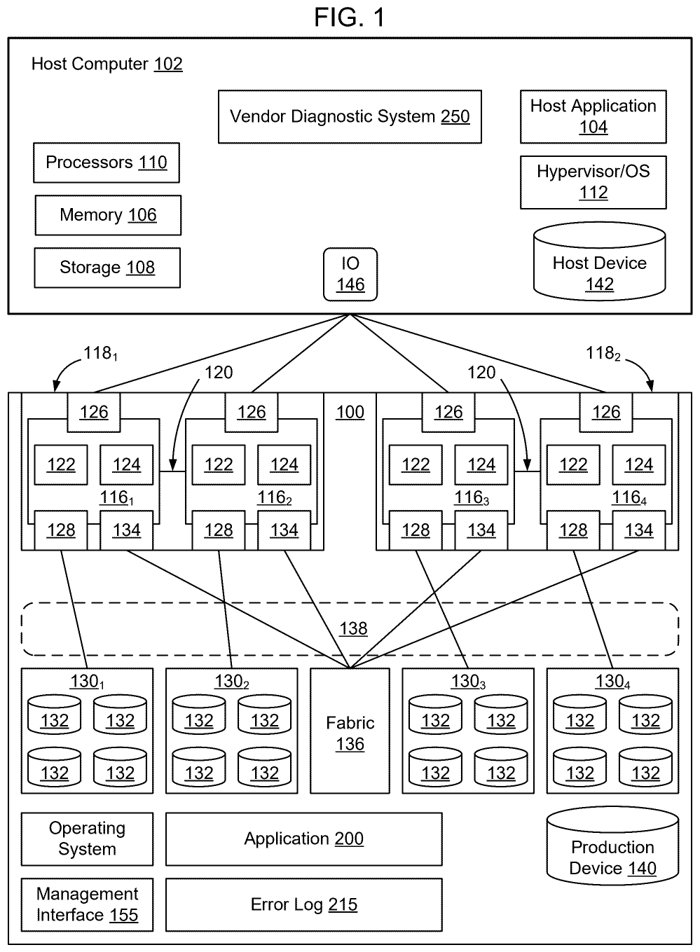

FIG. 1 illustrates a storage system 100 and an associated host computer 102, of which there may be many. The storage system 100 provides data storage services for a host application 104, of which there may be more than one instance and type running on the host computer 102. In the illustrated example, the host computer 102 is a server with host volatile memory 106, persistent storage 108, one or more tangible processors 110, and a hypervisor or OS (Operating System) 112. The processors 110 may include one or more multi-core processors that include multiple CPUs (Central Processing Units), GPUs (Graphics Processing Units), and combinations thereof. The host volatile memory 106 may include RAM (Random Access Memory) of any type. The persistent storage 108 may include tangible persistent storage components of one or more technology types, for example and without limitation SSDs (Solid State Drives) and HDDs (Hard Disk Drives) of any type, including but not limited to SCM (Storage Class Memory), EFDs (Enterprise Flash Drives), SATA (Serial Advanced Technology Attachment) drives, and FC (Fibre Channel) drives. The host computer 102 might support multiple virtual hosts running on virtual machines or containers.

The storage system 100 includes a plurality of compute nodes 116₁- 116₄, possibly including but not limited to storage servers and specially designed compute engines or storage directors for providing data storage services. In some embodiments, pairs of the compute nodes, e.g. (116₁- 116₂) and (116₃- 116₄), are organized as storage engines 118₁ and 118₂, respectively, for purposes of facilitating failover between compute nodes 116 within storage system 100. In some embodiments, the paired compute nodes 116 of each storage engine 118 are directly interconnected by communication links 120. As used herein, the term “storage engine” will refer to a storage engine, such as storage engines 118₁ and 118₂, which has a pair of (two independent) compute nodes, e.g. (116₁-116₂) or (116₃- 116₄). A given storage engine 118 is implemented using a single physical enclosure and provides a logical separation between itself and other storage engines 118 of the storage system 100. A given storage system 100 may include one storage engine 118 or multiple storage engines 118.

Each compute node, 116₁, 116₂, 116₃, 116₄, includes processors 122 and a local volatile memory 124. The processors 122 may include a plurality of multi-core processors of one or more types, e.g., including multiple CPUs, GPUs, and combinations thereof. The local volatile memory 124 may include, for example and without limitation, any type of RAM. Each compute node 116 may also include one or more front-end adapters 126 for communicating with the host computer 102. Each compute node 116₁-116₄ may also include one or more back-end adapters 128 for communicating with respective associated back-end drive arrays 130₁- 130₄, thereby enabling access to managed drives 132. A given storage system 100 may include one back-end drive array 130 or multiple back-end drive arrays 130.

In some embodiments, managed drives 132 are storage resources dedicated to providing data storage to storage system 100 or are shared between a set of storage systems 100. Managed drives 132 may be implemented using numerous types of memory technologies for example and without limitation any of the SSDs and HDDs mentioned above. In some embodiments the managed drives 132 are implemented using NVM (Non-Volatile Memory) media technologies, such as NAND-based flash, or higher-performing SCM (Storage Class Memory) media technologies such as 3D XPoint and ReRAM (Resistive RAM). Managed drives 132 may be directly connected to the compute nodes 116₁- 116₄, using a PCIe (Peripheral Component Interconnect Express) bus or may be connected to the compute nodes 116₁- 116₄, for example, by an IB (InfiniBand) bus or fabric.

In some embodiments, each compute node 116 also includes one or more channel adapters 134 for communicating with other compute nodes 116 directly or over an interconnecting fabric 136. An example interconnecting fabric 136 may be implemented using PCIe or IB. Each compute node 116 may allocate a portion or partition of its respective local volatile memory 124 to a virtual shared memory 138 that can be accessed by any compute node 116 of storage system 100.

The storage system 100 maintains data for host applications 104 running on the host computer 102. For example, host application 104 may write data of host application 104 to the storage system 100 and read data of host application 104 from the storage system 100 to perform various functions. Examples of host applications 104 may include but are not limited to file servers, email servers, block servers, and databases.

Logical storage devices are created and presented to the host application 104 for storage of the host application 104 data. For example, as shown in FIG. 1, a production device 140 and a corresponding host device 142 are created to enable the storage system 100 to provide storage services to the host application 104.

The host device 142 is a local (to host computer 102) representation of the production device 140. Multiple host devices 142, associated with different host computers 102, may be local representations of the same production device 140. The host device 142 and the production device 140 are abstraction layers between the managed drives 132 and the host application 104. From the perspective of the host application 104, the host device 142 is a single data storage device having a set of contiguous fixed-size LBAs (Logical Block Addresses) on which data used by the host application 104 resides and can be stored. However, the data used by the host application 104 and the storage resources available for use by the host application 104 may actually be maintained by the compute nodes 116₁- 116₄ at non-contiguous addresses (tracks) on various different managed drives 132 on storage system 100.

In some embodiments, the storage system 100 maintains metadata that indicates, among various things, mappings between the production device 140 and the locations of extents of host application data in the virtual shared memory 138 and the managed drives 132. In response to an IO (Input/Output command) 146 from the host application 104 to the host device 142, the hypervisor/OS 112 determines whether the IO 146 can be serviced by accessing the host volatile memory 106 or storage 108. If that is not possible then the IO 146 is sent to one of the compute nodes 116 to be serviced by the storage system 100.

In the case where IO 146 is a read command, the storage system 100 uses metadata to locate the commanded data, e.g., in the virtual shared memory 138 or on managed drives 132. If the commanded data is not in the virtual shared memory 138, then the data is temporarily copied into the virtual shared memory 138 from the managed drives 132 and sent to the host application 104 by the front-end adapter 126 of one of the compute nodes 116₁- 116₄.

In the case where the IO 146 is a write command, in some embodiments the storage system 100 copies a block being written into the virtual shared memory 138, marks the data as dirty, and creates new metadata that maps the address of the data on the production device 140 to a location to which the block is written on the managed drives 132.

As shown in FIG. 1, storage systems 100 are one example of a complex electrical computing system that may be configured in multiple ways to achieve multiple different types of functions. For example, the storage system 100 may be used by multiple host computers, and may include multiple executing applications that enable the configuration of the storage system to change over time and to provide different functions to the various connected hosts.

In some embodiments, storage systems such as the storage system 100 shown in FIG. 1 may include multiple executing applications 200 that are configured to provide access to data contained in the storage resources 130 and protect data stored in managed drives 132. As the applications execute, one or more of the applications may experience errors, which are logged in one or more error log files 215.

Due to the complex nature of storage systems, it is common for customers that purchase or rent the storage system to be provided with storage system maintenance services by a storage system vendor. The vendor can provide updated functionality in connection with application updates, and can provide corrective services in instances where one or more of the applications 200 has encountered an error. In some embodiments, to diagnose the cause of an error, the vendor accesses the log files 215 to enable the log files to be analyzed to determine the cause of the errors. For example, the vendor may use a form of vendor diagnostic system 250, to access the log files 215 to determine what type of errors were reported over time, to determine a likely reason why the one or more applications is experiencing execution errors. In instances where the source of an error is able to be isolated, the vendor diagnostic system 250 and/or a storage system management system may use a management interface 155 to take corrective action on the storage system to seek to avoid occurrence of subsequent similar errors. Error log files 215 are thus useful to the vendor since the error logs 215 contain a record of the types of occurrences of errors and when the errors were detected.

Some errors result in data corruption on the storage system 100. To diagnose either hardware or software errors that result in the data corruption, it may be useful or necessary for the vendor to be able to examine both the correct and incorrect user data. For example, a comparison between the corrupted and corrected data may result in a determination by the vendor that a particular portion of the data such as the first 2 bytes of a given file are consistently being written as all zeros. Thus, having the ability to examine the correct and incorrect data can provide the vendor with information that may be highly relevant to performing root cause analysis of the cause of the errors that are resulting in the data corruption.

However, customers may be reluctant to expose their data to the vendor that is tasked with maintaining/fixing the storage system. For example, if the customer is using the storage system to record financial transactions, the customer may be reluctant to enable the vendor to see the files that are associated with the financial transactions, or to even see the metadata associated with those files. Accordingly, in security-sensitive industries, the storage systems are configured to not include the user data in the log files. Thus, when the vendor accesses the log files, the log files do not include the corrupted data. Since corrupted data is frequently automatically corrected by the storage system once detected, the failure to log the corrupted data can result in the corrupted data being forever lost. This may make it difficult or impossible for the vendor to determine the root cause associated with one or more of the applications on the storage system that is causing the errors on the storage system.

According to some embodiments, a method and apparatus for privacy enabled logging of user data is provided. In some embodiments, when an error occurs that results in data corruption, a placeholder for the corrupted data and/or metadata associated with the error is stored in the log file. The placeholder contains pseudo data representing the corrupted data/metadata, but is formatted in such a way to prevent the vendor from accessing the content of the data/metadata without authorization from the customer. When reviewing the log file, the vendor has visibility to the pseudo data contained in the data placeholders, but is not able to discern the content of the user data from the pseudo data. In response to a request from the vendor to access the user data/metadata correlating to one or more of the placeholders, the customer can review the requested user data to identify instances of corrupted data/metadata that do not contain sensitive information. This enables the customer to retain control and prevent release of sensitive information that must not be provided to the vendor. When the user determines that certain instances of user data do not contain sensitive information, the pseudo data of a set of selected placeholders is then replaced with instances of the corrupted data/metadata to enable the vendor to selectively have access to the actual user data in connection with implementation of root cause analysis. In instances where the corrupted data is automatically corrected by the storage system, placeholders containing pseudo data may be included in the log file for both the corrupted data as well as the corresponding corrected data.

As used herein, the term “pseudo data” is used to refer to a construct that identifies the corrupted data but is formatted in such a manner that the vendor cannot access the corrupted data without prior permission from the customer. Example ways that the pseudo data may be formatted include inclusion in the log of a copy of the corrupted data that has been encrypted, or inclusion in the log of a reference to a secure location where the data is stored, either in encrypted or unencrypted form, that is secured against access without prior permission. For example, in some embodiments, the “pseudo data” for the user data is a copy of the corrupted data that has been encrypted using a customer's secret encryption key. In some embodiments, the pseudo data for the user data is a copy of the corrupted data that has been encrypted using an encryption key specific to that instance of the corrupted data. When the corrupted data is encrypted using a key specific to that instance of the corrupted data, the key is included in the log file along with encrypted user data, but the encryption key is itself encrypted using the customer's secret encryption key. In some embodiments, the pseudo data for the user data is a reference to an external storage location where the user data is stored, either in encrypted or unencrypted form. When the pseudo data for the user data is a reference to an external storage location, the external storage location is not available to the vendor without prior consent or action by the customer.

In response to a request for access to one or more instances of the user data, the customer can review the requested data associated with the pseudo data to determine if particular instances of the user data are not security sensitive. For example, in a banking context, some instances of the user data referenced by the pseudo data contained in placeholders in the error log might be associated with files that are used to store financial information or financial transactions. By contrast, other instances of user data referenced by the pseudo data contained in placeholders in the error log might be associated with news articles or other types of publicly available information. By providing the vendor with access to instances of user data that is associated with non-sensitive information, it is possible to enable the vendor to access particular instances of the user data in connection performance of root cause analysis without compromising security that is required to be implemented in connection with the security-sensitive data stored by the storage system.

Accordingly, by allowing the customer to supply an encryption key to the system, which is not known to the vendor, and which is used to encrypt any data stored in the log, the user data can be safely logged using placeholders containing pseudo data within the error log when data corruption or other application errors occur. If the customer wishes to allow the vendor to see particular instances of user data referenced by the corresponding instances of pseudo data in respective error log placeholders, the customer can decrypt particular instances of the user data using their secret encryption key.

Depending on the particular implementation, there are several ways that the customer may generate pseudo data for inclusion in corresponding placeholders in the error log files that will both (1) enable the corrupted user data to be preserved in the context of the logged error while (2) preventing the vendor from accessing the corrupted user data without obtaining additional prior permission from the customer. In this manner, permission to access the error log files, by itself, is not sufficient to enable the vendor to access the user data referenced by the placeholders contained in the error log.

In some embodiments, all pseudo data that is included in the log file is generated by encrypting user data using a single secret encryption key that is known to the customer but not known to the vendor. In this embodiment, the customer does not disclose the secret encryption key to the vendor to prevent the vendor from having access to the corresponding user data referenced by the pseudo data contained in the log file when the vendor accesses the log file to perform service operations on the storage system. By not providing the vendor with access to the secret encryption key, the customer can prevent the vendor from decrypting any past or future pseudo data that is contained in the log file. However, the customer can decrypt particular instances of the user data using a decryption tool, and send the log file containing placeholders with the actual user data to the vendor for use in connection with performance of root cause analysis. In some embodiments, the customer decrypts particular instances of the pseudo data and replaces the pseudo data of the placeholders with the decrypted user data. In other embodiments, the customer decrypts particular instances of the corrupted data and provides the decrypted data to the vendor separate from the log file. In some embodiments, the decrypted data has salt (extra data) added to it to reduce the risk of key disclosure to the vendor. In some embodiments, the customer reviews the instances of decrypted data to ensure that the decrypted data does not contain security sensitive information prior to providing the particular decrypted instances of customer data to the vendor.

In some embodiments, individual instances of pseudo data that are included in the log file are generated by encrypting corresponding instances of user data using different secret encryption keys. In these embodiments, the separate, perhaps randomly-generated, encryption keys are saved in the log file along with the encrypted corrupted data. To prevent the vendor from accessing the user data from the pseudo data contained in the log file, the encryption keys that are created to generate the different instances of pseudo data are themselves encrypted using the customer's secret encryption key. The placeholders that are included in the log file, in these embodiments, accordingly include the pseudo data generated by encrypting the corresponding instance of user data as well as the corresponding unique encryption key (which itself is encrypted) and which was used to generate the corresponding instance of pseudo data. Since the encryption keys are encrypted using the customer's secret encryption key, the vendor cannot use the encryption keys in the log file to decrypt the pseudo data contained in the log file, until the customer decrypts a particular subset of the encryption keys associated with specific instances of data that the customer elects to share with the vendor. Accordingly, after review by a security officer, a customer may choose to share user data with the vendor and can decrypt particular keys and send the keys to the vendor for the specific pieces of user data that the customer would like to share with the vendor. The vendor can then convert the particular instances of pseudo data into user data, for example in connection with performance of root cause analysis associated with particular errors that are occurring on the storage system.

In a secure environment, some degree of certification would be required for a customer to accept that the logged data is actually unreadable by the vendor without the key. Alternatively, logged data could be kept only on the storage system, in encrypted form, and never transferred to the vendor. The customer could then decrypt any particular selected instances of logged data that are deemed to be sharable with the vendor and send the selected instances of user data to the vendor.

In some embodiments, rather than including encrypted data as the pseudo data in the placeholders in the log files, the pseudo data that is included in the placeholders are references to locations where the user data is stored in a separate storage facility such as a separate server or separate file. The user data that is stored at the separate storage facility may be unencrypted or encrypted, depending on the implementation. In a tightly controlled environment, where the vendor does not have the ability to log into or otherwise access the separate storage facility, the customer retains control over the user data without providing any copy (encrypted or non-encrypted) to the vendor in connection with supplying the log files. The log files contain placeholders with pseudo data that contain references to the locations where the corrupted data is stored in the separate storage facility, which enables the vendor to ask the customer for access to particular instances of the user data.

By always logging potentially sensitive data upon occurrence of an error, it is possible to improve the chance of diagnosing problems on the storage system without requiring the error to be reproduced. By enabling the customer to retain control of the user data, by preserving the user data in a format that is not natively accessible to the vendor without the customer's authorization and participation, it is possible to ensure the integrity and security of the customer data, while enabling the user data associated with errors to be included in the error logs in a privacy enhanced manner. Specifically, by including placeholders for the user data in the error logs, in which the placeholders contain instances of pseudo data, it is possible to preserve the user data associated with the error while preventing the user data from being directly accessible to someone that is otherwise authorized to view and access the error logs.

Although some embodiments described herein have referred to information that is included in the log files as “customer data” or “user data”, it should be understood that the term “customer data” as that term is used herein includes metadata as well as the actual data associated with the metadata.

There are many types of errors that might be logged on a storage system, where including a placeholder for the customer data might be useful to the vendor in connection with debugging the root cause of the error. As an example, a login failure may occur where the username of the person that was attempting to log in might be logged by the customer, but where the customer may not want to disclose details of their users, or potentially a password, or network infrastructure to the system vendor. In this case, in some embodiments both the username and optionally IP address may be replaced with placeholders. Each placeholder contains corresponding pseudo data that does not enable the original data to be discerned, but which is able to be converted back into the original user data at a subsequent point in time. For example, in the following message, the username and IP address are determined to be sensitive user data. Accordingly, when an error is logged such as:
Unknown user isg-admin from 10.205.206.15
   The error that is included in the log may contain two placeholders, each of which contains corresponding pseudo data, such that the error log may include the following error message:
Unknown user $enc$7q4tz97kvO$ from $enc$an4dIMptrS70_k4Z$
   By including placeholders for the username and IP address, and including pseudo data that is generated by encoding the username and IP address that is used to populate the content of the corresponding placeholders, it is possible to provide the vendor with the complete error log without compromising customer security. In the event that the vendor subsequently requests access to the actual user data represented by the pseudo data contained in one or more of the placeholders, the customer can determine whether the actual data should be provided and selectively provide the vendor with access to the data represented by the pseudo data of one or more of the placeholders. For example, the vendor could elect to share the IP address with the vendor while keeping the username secret.

In some embodiments, the placeholder includes both pseudo data and a descriptor of the type of information encoded by the pseudo data. For example, in the above example the respective placeholders in the error message contained in the error log may include corresponding data identifier such as “username” and “IP address”, such that the error log may include the following error message:
Unknown user (username: $ENC$7q4tz97kvO$) from (IP Address: $ENC$aN4DIMpTrS70_k4Z$)

As another example, metadata such as filenames might be important to the customer and might be considered sensitive information. Accordingly, rather than including the actual metadata (e.g., filenames) in the log file, placeholders may be included in the error log which include pseudo data generated for the metadata, such that the vendor does not automatically have access to the user's actual metadata when reviewing the log files. For example, the following message:
Failed to copy /project/hawaiian-hotel/bids/sbcorp to the destination may be replaced in the logs with:
Failed to copy $ENC$ZFpq7zMt4219xk1u99p4FZdKoRzNpQV1NR74DQZp02$ to the destination
   By encoding the metadata such as filenames with pseudo data, and including placeholders in the log files which contain the corresponding pseudo data, it is possible to provide the vendor with the complete log without compromising customer security. In the event that the vendor subsequently requests access to the actual data represented by the pseudo data of one or more of the placeholders, the customer can determine whether the actual data should be provided and selectively provide the vendor with access to the data referenced by the corresponding pseudo data of one or more of the placeholders.

As yet another example, decompression failures generally relate to particular instances of user data. To enable the data to be preserved, while not automatically providing the data to the vendor, in some embodiments the data is preserved and used to generate pseudo data that is included in a placeholder within the error log. For example, the following error log messages:
Decompression error 6 (algorithm: gzip)
Compressed data (117 bytes): 1F 8B 27 41 88 92 4D E2 . . . (117 bytes of data total)
   may be replaced in the logs with:
Decompression error 6 (algorithm: gzip)
Compressed data (117 bytes): $ENC$4k7zFO0PQN . . . $ (again, 117 bytes but this time encrypted & potentially formatted differently)
   Alternatively, the decompressed data could be stored elsewhere, such that the pseudo data that is included in the placeholder in the error log is a reference to the location where the data is stored. In instances where the location is secured, the vendor does not have access to the data via the placeholder until authorized by the customer. In this example, the original messages in the log may be replaced with:
Decompression error 6 (algorithm: gzip)
Compressed data (117 bytes) written to/log/errordata.2024.09.20.08.17.22.03

In this case the log message itself would be identical, but the contents of the referenced file (/log/errordata.2024.09.20.08.17.22.003 in this example) would be compressed but unencrypted data prior to this invention (e.g. the 1F 8B 27 41 88 92 4D E2 . . . from the previous example), and compressed and encrypted according to some embodiments.

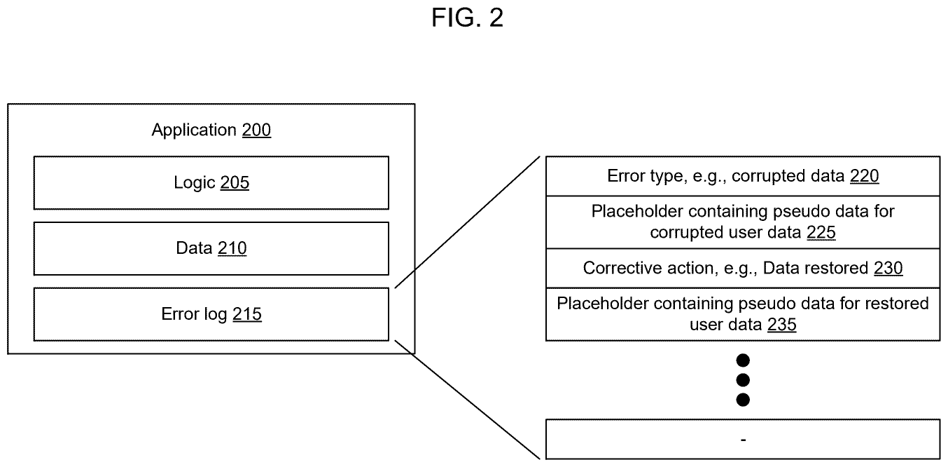

FIG. 2 is a block diagram showing example application 200 including control logic 205 configured to implement operations on application data 210, and containing an error log 215 in which application actions and execution errors are recorded, according to some embodiments. Multiple types of applications 200 may contain various instances of logic 205. During execution, one or more of the applications 200 may experience errors or failures, and information regarding the execution errors are stored in an error log 215. As noted above, there are many types of errors, such as data corruption errors, login errors, file access errors, etc.

To enable the source of an error to be evaluated, in some instances it would be beneficial to have access to the user data that was being handled by the application at the time of the error. For example, if a particular piece of user data was determined to be corrupted, in addition to logging an error message in the error log 215, e.g. “corrupt data” it may be useful to also preserve the user data that was determined to be corrupt in the user log. As shown in FIG. 2, in some embodiments errors that are associated with user data are stored in the error log 215 together with placeholders containing pseudo data corresponding to the relevant user data. For example, in some embodiments a given error will include an error type 220 and a set of one or more placeholders 225 containing pseudo data for user data associated with the error type 220. In instances where corrective action 230 is automatically implemented by the storage system in response to determination of the logged error 220, the log may similarly include an entry for the corrective action 230 and optionally a placeholder containing pseudo data for the corrected user data associated with the corrective action 235. As noted above, the pseudo data does not enable access to the user data from the error log without action by a third party. Thus, by including placeholders 225 for the user data in the error log 215, and including pseudo data in the placeholders 225, it is possible to provide privacy-enhanced logging of user data that enables instances of the user data to be preserved in the error logs without giving automatic access to the instances of the user data in connection with providing access to the error log. This second level of control over the user data enables the user data to be securely preserved, while enabling a vendor to access the error logs in connection with providing customer support for the storage system.

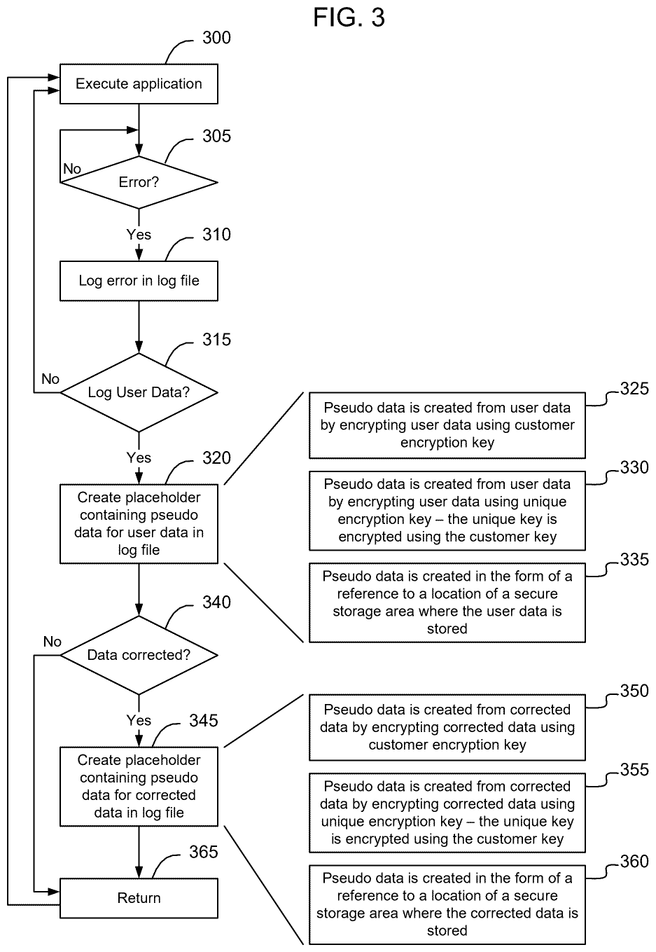

FIG. 3 is a block diagram showing an example process of privacy enhanced logging of user data, in which user data is logged in an error log using placeholders containing pseudo data, according to some embodiments. As shown in FIG. 3, in some embodiments an application is executing (block 300). While executing, the application is monitored for execution errors (block 305). In response to determination that there was an execution error (a determination of YES at block 305), the error is logged in a log file (block 310).

A determination is then made if user data should be logged in connection with the error (block 315). For example, if the error was associated with corrupted user data, storing the corrupted data in the error log may enable the type of corruption to be inspected at a later date. In this and other instances, it may be advantageous to include a placeholder in the log file and create pseudo data for the user data that is included in the placeholder, such that the user data is able to be subsequently retrieved from the error log if access to the user data is determined to be allowable.

Accordingly, in response to a determination that user data should be logged (a determination of YES at block 315), a placeholder is created in the error log and pseudo data is created from the user data and included in the placeholder (block 320). In some embodiments, as shown in FIG. 3, the pseudo data that is included in the placeholder is created by encrypting the user data using a customer key, and the encrypted user data is then included in the log file (block 325). In some embodiments, the customer key that is used to encrypt the user data is a one-time key, and the one-time key as well as the encrypted data is stored in the log file. In these embodiments, the one-time key that was used to encrypt the instance of the user data is encrypted using the customer key (block 330). In some embodiments, the placeholder is created by creating a reference to a separate storage area where the user data is stored, and the reference to the location of the data is stored in the log file (block 335). Optionally, the reference to the location of the data may also be encrypted using the customer key. By storing the user data separate from the logs in a secure server or secure location in the cloud that is not accessible without permission of the customer, it is possible to include pseudo data in the placeholder that references the storage location without automatically providing the user data to the vendor when the vendor accesses the error log.

As shown in FIG. 3, in some embodiments where the software is able to recover from occurrence of an error, the error log may include an indication of the recovery actions that were implemented in response to occurrence of the error (block 340). For example, if the error that was identified in block 305 is a data corruption error, the storage system may be able to recover from the data corruption error to correct the data (block 340). In response to a determination that the data was recovered (a determination of YES at block 340), in some embodiments an entry for the storage system response is included in the log file (block 345). For example, as shown in FIG. 3, in instances where the corrupted user data is corrected, a placeholder for the corrected data may be included in the error log (block 345). In instances where the corrected user data is determined to be included in the log file in block 345, a placeholder for the user data is created that includes pseudo data generated from the corrected user data (blocks 350, 355, 360). In response to a determination that a placeholder should not be created, for example in instances where the data is not corrected (a determination of NO at block 340), the process returns (block 365).

In some embodiments, in response to a determination that the data has been corrected (a determination of YES at block 340), a placeholder is created in the error log and pseudo data is created from the user data and included in the placeholder (block 345). In some embodiments, as shown in FIG. 3, the pseudo data that is included in the placeholder is created by encrypting the corrected data using a customer key, and the encrypted corrected data is then included in the log file (block 350). In some embodiments, the customer key that is used to encrypt the user data is a one-time key, and the one-time key as well as the encrypted corrected data is stored in the log file. In these embodiments, the one-time key that was used to encrypt the instance of the corrected data is encrypted using the customer key (block 355). In some embodiments, the placeholder is created by creating a reference to a separate storage area where the corrected data is stored, and the reference to the location of the data is stored in the log file (block 360). Optionally, the reference to the location of the corrected data may also be encrypted using the customer key. By storing the corrected data separate from the logs in a secure server or secure location in the cloud that is not accessible without permission of the customer, it is possible to include pseudo data in the placeholder that references the storage location without automatically providing the corrected data to the vendor when the vendor accesses the error log.

When a person is reviewing the logs, for example a vendor is reviewing the logs to determine the types of errors that are occurring on the storage system, the vendor can request access to particular instances of user data and/or corrected user data that are referenced by the placeholders that are included in the log file. The customer can then determine whether the requested data contains sensitive information and selectively make the user data available to the vendor upon request. Since the user data that the application was processing at the time of occurrence of an error is correlated within the error logs, it is possible to look at not only the error code but also the actual data that was being processed by the application at the time of the error, which can facilitate root cause analysis as to why the application execution error occurred. By ensuring that the error logs include pseudo data that is able to be used to recreate the user data, it is possible to ensure that the user data associated with the particular errors is able to be preserved even in instances where the storage system is configured to automatically correct the user data once occurrence of an error is identified.

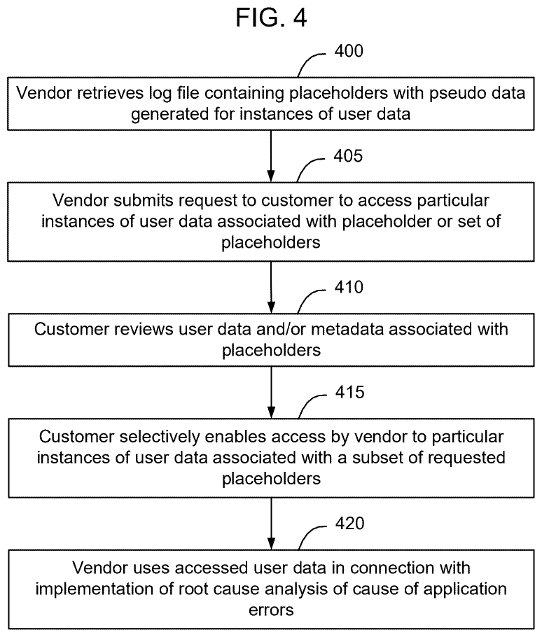

FIG. 4 is a flow chart of an example process of privacy enhanced logging of user data, in which pseudo data instances of selected placeholders are converted to user data to enable a vendor to access to the user data in the log file, according to some embodiments. As shown in FIG. 4, in some embodiments the vendor retrieves a log file containing placeholders containing pseudo data generated for corresponding instances of user data associated with the corresponding error messages (block 400). The vendor then submits a request to the customer to access particular instances of user data and/or corrected user data that have been replaced in the error logs with corresponding pseudo data. For example, if the vendor sees a data corruption error in the error log, the vendor may request access to the corrupted user data and/or the corrected user data associated with the placeholder or the set of placeholders that were included in the error log (block 405).

The customer reviews the user data associated with the placeholder (block 410). In instances where the pseudo data is generated by encrypting the user data using the customer's secret encryption key, the user data may be obtained by the customer by decrypting the pseudo data using the customer's secret encryption key. In instances where the pseudo data contains a reference to a secure storage location that is accessible by the customer but not accessible by the vendor, the customer can review the user data by accessing the secure storage location. In both instances, the customer has access to the actual user data, e.g. the data in unencrypted form, and makes a determination as to whether the requested user data should be provided to the vendor. The customer selectively enables access by the vendor to particular instances of the corrupted data and/or corrected data associated with a subset of the requested placeholders (block 415). The vendor then uses the accessed corrupted data and/or corrected data in connection with implementation of root cause analysis of errors that resulted in the data corruption (block 420). By including the data in the error logs, in the form of pseudo data, it is possible to ensure that the user data is preserved and is able to be made available in the context of the user logs. By providing the customer with control over which particular instances of pseudo data are able to be converted to actual user data, it is possible to ensure the confidentiality of the sensitive customer data. By providing the vendor with selected access to the user data, it is possible for the vendor to view not only the error codes but also the actual data (both pre correction and post correction) that was being processed by the application at the time of occurrence of the corresponding error, which can be useful in connection with root cause analysis of why the error occurred. This makes it much more likely that the root cause analysis will be successful, and optionally may reduce the amount of work required to perform the root cause analysis, by reducing the need for the vendor to recreate the errors when performing the root cause analysis.

The methods described herein may be implemented as software configured to be executed in control logic such as contained in a CPU (Central Processing Unit) or GPU (Graphics Processing Unit) of an electronic device such as a computer. In particular, the functions described herein may be implemented as sets of program instructions stored on a non-transitory tangible computer readable storage medium. The program instructions may be implemented utilizing programming techniques known to those of ordinary skill in the art. Program instructions may be stored in a computer readable memory within the computer or loaded onto the computer and executed on computer's microprocessor. However, it will be apparent to a skilled artisan that all logic described herein can be embodied using discrete components, integrated circuitry, programmable logic used in conjunction with a programmable logic device such as a FPGA (Field Programmable Gate Array) or microprocessor, or any other device including any combination thereof. Programmable logic can be fixed temporarily or permanently in a tangible non-transitory computer readable medium such as random-access memory, a computer memory, a disk drive, or other storage medium. All such embodiments are intended to fall within the scope of the present invention.

Throughout the entirety of the present disclosure, use of the articles “a” or “an” to modify a noun may be understood to be used for convenience and to include one, or more than one of the modified noun, unless otherwise specifically stated. The term “about” is used to indicate that a value includes the standard level of error for the device or method being employed to determine the value. The use of the term “or” in the claims is used to mean “and/or” unless explicitly indicated to refer to alternatives only or the alternatives are mutually exclusive, although the disclosure supports a definition that refers to only alternatives and to “and/or.” The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and also covers other unlisted steps.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Various changes and modifications of the embodiments shown in the drawings and described in the specification may be made within the spirit and scope of the present invention. Accordingly, it is intended that all matter contained in the above description and shown in the accompanying drawings be interpreted in an illustrative and not in a limiting sense. The invention is limited only as defined in the following claims and the equivalents thereto.

What is claimed is:

1. A method of privacy enabled logging of user data, comprising:
determining occurrence of errors generated by an executing application, the executing application being used to process individual instances of user data;
logging the errors in an error log;
for each error of a subset of the errors:
identifying a corresponding instance of the user data that the executing application was processing at a time of occurrence of the error;
generating a placeholder for the corresponding instance of the user data in the error log;
generating a corresponding instance of pseudo data for the corresponding instance of the user data that the executing application was processing at the time of occurrence of the error; and
including the generated corresponding instance of pseudo data in the placeholder in the error log.

2. The method of claim 1, wherein generating a corresponding instance of pseudo data comprises encrypting the corresponding instance of the user data that the executing application was processing at the time of occurrence of the error using an encryption key.

3. The method of claim 2, wherein the same encryption key is used to generate corresponding instances of pseudo data for each error of the subset of the errors.

4. The method of claim 2, wherein corresponding different encryption keys are used to generate respective corresponding instances of pseudo data for each error of the subset of the errors.

5. The method of claim 4, further comprising encrypting corresponding different encryption keys for the respective corresponding instances of the pseudo data and storing the encrypted corresponding different encryption keys along with the respective corresponding instances of the pseudo data in the corresponding placeholders in the error log.

6. The method of claim 1, wherein generating a corresponding instance of pseudo data comprises storing the corresponding instance of the user data that the executing application was processing at the time of occurrence of the error at a secure storage location, and including a reference to the secure storage location as the pseudo data in the placeholder in the error log.

7. The method of claim 6, wherein the secure storage location is a second storage location separate from a first storage location containing the error log, and wherein access to the first storage location containing the error log does not provide corresponding access to the second storage location containing the user data.

8. The method of claim 7, wherein the user data is stored in encrypted form at the second storage location.

9. The method of claim 1, further comprising accessing the error log;
requesting access to user data corresponding to particular instances of the pseudo data contained in one or more of the placeholders;
reviewing particular instances of user data corresponding to the requested particular instances of pseudo data to determine if the particular instances of pseudo data should be replaced with the particular instances of user data;
for each instance of pseudo data:
in response to a determination that the particular instance of pseudo data should be replaced with corresponding user data, replacing the pseudo data of the corresponding placeholder with the corresponding user data in the error log; and
in in response to a determination that the particular instance of pseudo data should not be replaced with corresponding user data, maintaining the pseudo data of the corresponding placeholder in the error log.

10. A system for privacy enabled logging of user data, comprising:
one or more processors and one or more storage devices storing instructions that are configured, when executed by the one or more processors, to cause the one or more processors to perform operations comprising:
determining occurrence of errors generated by an executing application, the executing application being used to process individual instances of user data;
logging the errors in an error log;
for each error of a subset of the errors:
identifying a corresponding instance of the user data that the executing application was processing at a time of occurrence of the error;
generating a placeholder for the corresponding instance of the user data in the error log;
generating a corresponding instance of pseudo data for the corresponding instance of the user data that the executing application was processing at the time of occurrence of the error; and
including the generated corresponding instance of pseudo data in the placeholder in the error log.

11. The system of claim 10, wherein generating a corresponding instance of pseudo data comprises encrypting the corresponding instance of the user data that the executing application was processing at the time of occurrence of the error using an encryption key.

12. The system of claim 11, wherein the same encryption key is used to generate corresponding instances of pseudo data for each error of the subset of the errors.

13. The system of claim 11, wherein corresponding different encryption keys are used to generate respective corresponding instances of pseudo data for each error of the subset of the errors.

14. The system of claim 13, further comprising encrypting corresponding different encryption keys for the respective corresponding instances of the pseudo data and storing the encrypted corresponding different encryption keys along with the respective corresponding instances of the pseudo data in the corresponding placeholders in the error log.

15. The system of claim 10, wherein generating a corresponding instance of pseudo data comprises storing the corresponding instance of the user data that the executing application was processing at the time of occurrence of the error at a secure storage location, and including a reference to the secure storage location as the pseudo data in the placeholder in the error log.

16. The system of claim 15, wherein the secure storage location is a second storage location separate from a first storage location containing the error log, and wherein access to the first storage location containing the error log does not provide corresponding access to the second storage location containing the user data.

17. The system of claim 16, wherein the user data is stored in encrypted form at the second storage location.

18. The system of claim 1, further comprising accessing the error log;
requesting access to user data corresponding to particular instances of the pseudo data contained in one or more of the placeholders;
reviewing particular instances of user data corresponding to the requested particular instances of pseudo data to determine if the particular instances of pseudo data should be replaced with the particular instances of user data;
for each instance of pseudo data:
in response to a determination that the particular instance of pseudo data should be replaced with corresponding user data, replacing the pseudo data of the corresponding placeholder with the corresponding user data in the error log; and
in in response to a determination that the particular instance of pseudo data should not be replaced with corresponding user data, maintaining the pseudo data of the corresponding placeholder in the error log.
